(19) United States
(12) Patent Application Publication
(10) Pub. No.: US 2026/0032794 A1
(43) Pub. Date: Jan. 29, 2026

(54) REFRIGERATOR WITH AMBIENT LIGHT SENSOR

(71) Applicant: Springhouse Technologies Inc., McLean, VA (US)

(72) Inventors: Boris Kontorovich, Brooklyn, NY (US); Bryce Copenhaver, Brooklyn, NY (US); Tyler Sanborn, Queens, NY (US); John Anderson, Brooklyn, NY (US); Deqing Sun, New York, NY (US)

(21) Appl. No.: 18/787,133

(22) Filed: Jul. 29, 2024

(51) Int. Cl. H05B 47/11; F21V 33/00; F21W 131/305; H05B 47/115

(52) U.S. Cl. CPC H05B 47/11; F21V 33/0044; H05B 47/115; F21W 2131/305

(57) ABSTRACT

A refrigerator system includes a main body and a door mounted to and movable with respect to the main body, an ambient light sensor, a light source, at least one camera positioned to have a field of view that includes an entrance opening leading to the at least one storage compartment, and at least one computing device in operable connection with the at least one camera, the ambient light sensor, and the light source. The at least one computing device is configured to determine an ambient light parameter outside of the main body based on signals received from the ambient light sensor, and to control at least one of the light source and the at least one camera based on the ambient light parameter that has been determined

### BACKGROUND

Known refrigerators can include a camera for imaging and recording inventory disposed in an interior of the refrigerator. US 2016/0088262 A1 discloses a refrigerator that includes an imaging unit, a data storage unit, a control unit and a display unit. The imaging unit generates a goods loading/unloading video through video recording of storage goods loaded into or unloaded from the refrigerator. U.S. Pat. No. 11,692,769 B2 discloses a refrigerator appliance including a cabinet defining a chilled chamber, a door rotatably hinged to the cabinet to provide selective access to the chilled chamber, and a camera assembly mounted to the cabinet for monitoring the chilled chamber. A controller is operably coupled to the camera assembly and is configured to obtain a raw image using the camera assembly, analyze the raw image to identify an anchor object, crop the raw image to generate a reduced image surrounding the anchor object, and analyze the reduced image to identify a food item being added to or removed from the chilled chamber.

Image capture and analysis can be improved by taking into account ambient light around the refrigerator.

### SUMMARY

A refrigerator system includes a main body and a door mounted to and movable with respect to the main body. The door is movable between an open position and a closed position, and the main body defines at least one storage compartment within a refrigerated enclosure when the door is in the closed position. An ambient light sensor is mounted to the main body or to the door, a light source is mounted to the main body or to the door, at least one camera is positioned to have a field of view that includes an entrance opening leading to the at least one storage compartment, and at least one computing device is in operable connection with the at least one camera, the ambient light sensor, and the light source. The light source is configured to illuminate the refrigerated enclosure when the door is in the open position. The at least one camera is configured to capture images of an item being loaded into or being removed from the at least one storage compartment. The at least one computing device is configured to determine an ambient light parameter outside of the main body based on signals received from the ambient light sensor, and to control at least one of the light source and the at least one camera based on the ambient light parameter that has been determined.

A computer-implemented method for operating a refrigerator includes starting a session, via at least one computing device, in response to a start trigger signal received by the at least one computing device indicating a door to the refrigerator has moved from a closed position to an open position; measuring, via an ambient light sensor, an ambient light parameter at least in front of the door of a refrigerator; and controlling, during the session, at least one of a light source and a camera, via the at least one computing device in communication with the light source and the camera, based on the ambient light parameter and the start trigger signal.

### BRIEF DESCRIPTION OF THE DRAWINGS

FIG. 1 is a block diagram illustrating a refrigerator system.

FIG. 2 is a front view of a refrigerator with a door shown in an open position.

FIG. 3 is a perspective view of the refrigerator with the door shown in the open position.

FIG. 4 is a flow diagram of a computer-implemented method for controlling components of the refrigerator based on signals received from an ambient light sensor.

FIG. 5 is an illustration of an example computer-readable medium or computer-readable device including processor-executable instructions configured to embody one or more of the provisions set forth herein.

### DETAILED DESCRIPTION

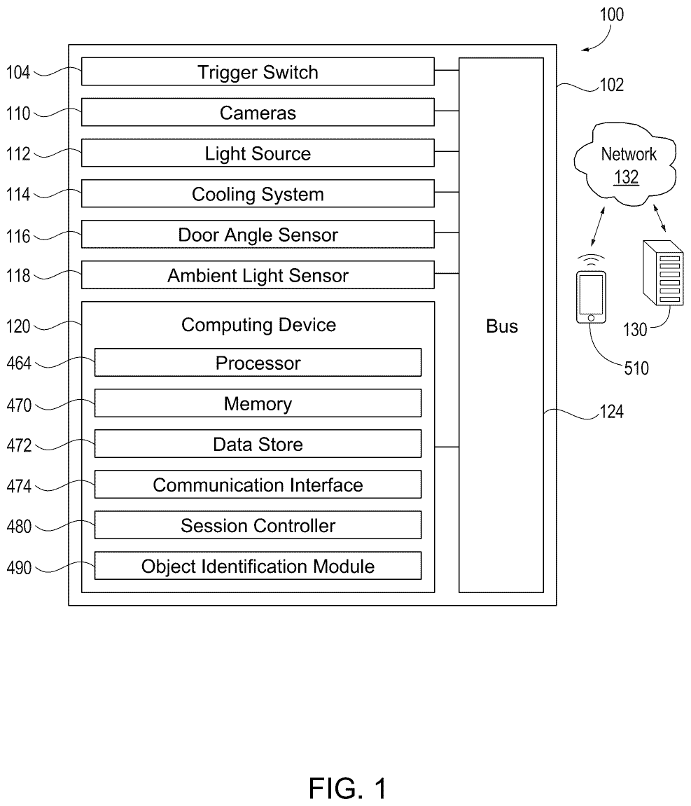

Referring now to the drawings, which are for purposes of illustrating one or more embodiments and not for purposes of limiting the same, FIG. 1 is a component diagram of an operating environment 100 of a refrigerator 102 including a trigger switch 104, a plurality of cameras 110, a light source 112, a cooling system 114, a door angle sensor 116, an ambient light sensor 118 and a computing device 120. Each of the trigger switch 104, the plurality of cameras 110, the light source 112, the cooling system 114, the ambient light sensor 118 and the computing device 120 may be interconnected by a bus 124. The components of the operating environment 100, as well as the components of other systems, hardware architectures, and software architectures discussed herein, may be combined, omitted, or organized into different architectures for various embodiments.

The computing device 120 may be implemented as a part of the refrigerator 102 or another device, e.g., a remote server 130, connected via a network 132. The computing device 120 may be capable of providing wired or wireless computer communications utilizing various protocols to send and receive electronic signals internally to and from components of the operating environment 100. Additionally, the computing device 120 may be operably connected for internal computer communication via the bus 124 (e.g., a Controller Area Network (CAN) or a Local Interconnect Network (LIN) protocol bus) to facilitate data input and output between the computing device 120 and the components of the operating environment 100.

The cooling system 114 can be similar to those found in known refrigerators, and therefore will not be described in detail. The cooling system 114 can include temperature sensors for sensing temperatures within the refrigerator 102 and air blower fans supplying air cooled by cooling devices (not shown), which can include a compressor (not shown) compressing refrigerant, a condenser (not shown) condensing the compressed refrigerant, an expansion valve (not shown) decompressing the condensed refrigerant, and an evaporator (not shown) evaporating the decompressed refrigerant.

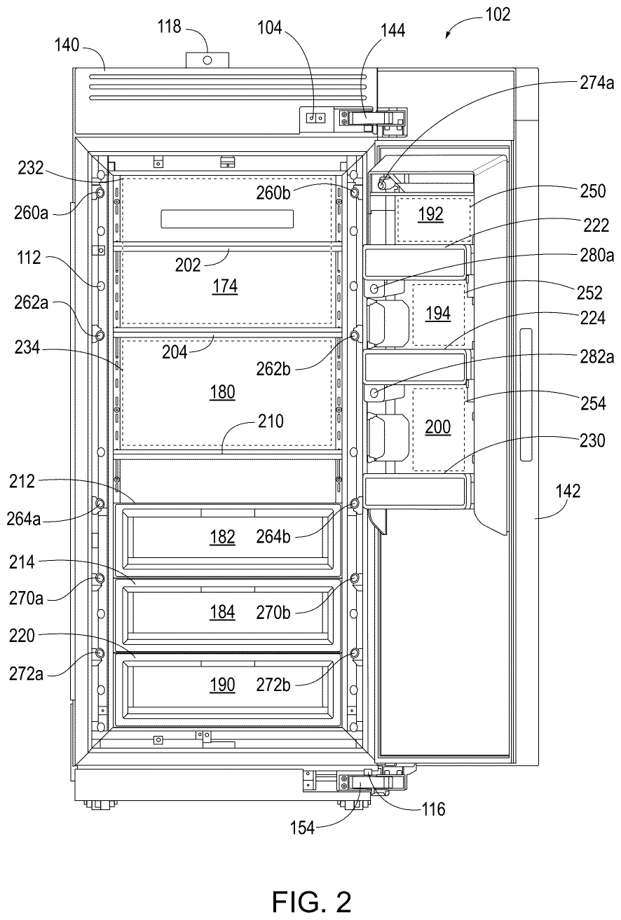

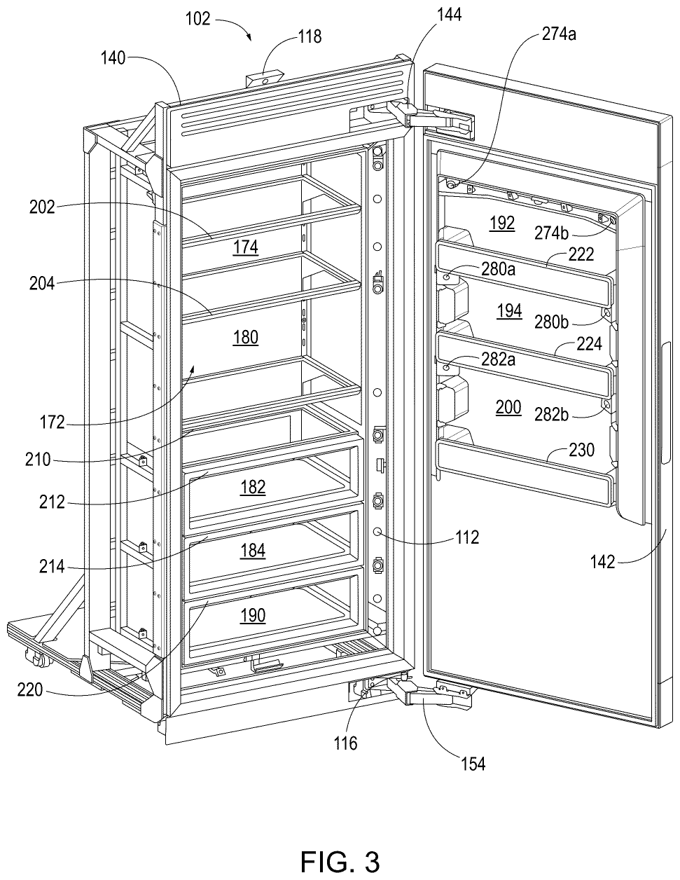

As shown in FIG. 2, the refrigerator 102 includes a main body 140 and a door 142 pivotally mounted to and movable with respect to the main body 140 between an open position and a closed position similar to known refrigerators. The door 142 is connected to the main body 140 through an upper hinge 144 and a lower hinge 154. As shown in FIG. 3, the main body 140 and the door 142 define at least one storage compartment within a refrigerated enclosure 172 when the door 142 is in the closed position. In the illustrated embodiment, the at least one storage compartment includes a plurality of storage compartments, which includes a first storage compartment 174, a second storage compartment 180, a third storage compartment 182, a fourth storage compartment 184, a fifth storage compartment 190, which are each located within the main body 140 in the illustrated embodiment. A sixth storage compartment 192, a seventh storage compartment 194, and an eighth storage compartment 200 are located on the door 142 in the illustrated embodiment. The number and location of the storage compartments 174, 180, 182, 184, 190, 192, 194 and 200 may differ from that shown in FIGS. 2 and 3.

As illustrated in FIGS. 2 and 3, a first shelf 202 and a second shelf 204 are disposed in the first storage compartment 174. A third shelf 210 is disposed in the second storage compartment 180. A first drawer 212 is disposed in the third storage compartment 182. A second drawer 214 is disposed in the fourth storage compartment 184. A third drawer 220 disposed in the fifth storage compartment 190. A first bin 222 is disposed in the sixth storage compartment 192. A second bin 224 is disposed in the seventh storage compartment 194. A third bin 230 is disposed in the eighth storage compartment 200.

Each storage compartment 174, 180, 182, 184, 190, 192, 194 and 200 defines a respective entrance opening through which items may be placed into and taken out of the corresponding storage compartment. More specifically and with reference to FIG. 2, the first storage compartment 174 defines a first entrance opening 232 leading onto the first shelf 202 and the second shelf 204, and the second storage compartment 180 defines a second entrance opening 234 leading onto the third shelf 210. The third storage compartment 182 defines a third entrance opening (not visible in FIGS. 2 and 3) leading into the first drawer 212, the fourth storage compartment 184 defines a fourth entrance opening (not visible in FIGS. 2 and 3) leading into the second drawer 214, and the fifth storage compartment 190 defines a fifth entrance opening (not visible in FIGS. 2 and 3) leading into the third drawer 220 when the respective drawers 212, 214, 220 are opened. The sixth storage compartment 192 defines a sixth entrance opening 250 leading into the first bin 222, the seventh storage compartment 194 defines a seventh entrance opening 252 leading into the second bin 224, and the eighth storage compartment 200 defines an eighth entrance opening 254 leading into the third bin 230.

The plurality of cameras 110 is mounted to the main body 140 and the door 142 for capturing images of objects moving into and out of the plurality of storage compartments 174, 180, 182, 184, 190, 192, 194 and 200. The plurality of cameras 110 includes a first set of cameras 260a, 260b mounted on the main body 140 associated with the first storage compartment 174, a second set of cameras 262a, 262b mounted on the main body 140 associated the second storage compartment 180, a third set of cameras 264a, 264b mounted on the main body 140 associated with the third storage compartment 182, a fourth set of cameras 270a, 270b mounted on the main body 140 associated with the fourth storage compartment 184, and a fifth set of cameras 272a, 272b mounted on the main body 140 associated with the fifth storage compartment 190. As more clearly seen in FIG. 3, the plurality of cameras 110 also includes a sixth set of cameras 274a, 274b mounted on the door 142 associated with the sixth storage compartment 192, a seventh set of cameras 280a, 280b mounted on the door 142 associated with the seventh storage compartment 194, and an eighth set of cameras 282a, 282b mounted on the door 142 associated with the eighth storage compartment 200.

As shown between FIGS. 2 and 3, the cameras with a suffix “a” are positioned at a left side of the corresponding storage compartment, and the cameras with a suffix “b” are positioned at a right side of the corresponding storage compartment. Instead of having a field of view towards the interior of the refrigerator 102, each camera among the plurality of cameras 110 has a field of view directed away from the interior of the refrigerator 102. The first set of cameras 260a, 260b are positioned in a top portion of the first storage compartment 174 above the first shelf 202 and the second shelf 204 with a field of view encompassing the first entrance opening 232. The second set of cameras 262a, 262b are positioned at a top portion of the second storage compartment 180 above the third shelf 210 with a field of view encompassing the second entrance opening 234. The third set of cameras 264a, 264b are positioned above the first drawer 212 with a field of view encompassing the third entrance opening (not visible in FIGS. 2 and 3) leading into the first drawer 212 when the first drawer 212 is opened. The fourth set of cameras 270a, 272b are positioned above the second drawer 214 with a field of view encompassing the fourth entrance opening (not visible in FIGS. 2 and 3) leading into the second drawer 214 when the second drawer 214 is opened. The fifth set of cameras 272a, 272b are positioned above the third drawer 220 with a field of view encompassing the fifth entrance opening (not visible in FIGS. 2 and 3) leading into the third drawer 220 when the third drawer 220 is opened.

The sixth set of cameras 274a, 274b are mounted to the door 142 above the first bin 222 with a field of view encompassing the sixth entrance opening 250. The seventh set of cameras 280a, 280b are mounted to the door 142 above the second bin 224 with a field of view encompassing the seventh entrance opening 252. The eighth set of cameras 282a, 282b are mounted to the door 142 above the third bin 230 with a field of view encompassing the eighth entrance opening 254. In this manner, each camera in the plurality of cameras 110 is positioned to have a field of view that includes a respective entrance opening leading to the corresponding storage compartment when the door 142 is in the open position. With this construction, the plurality of cameras 110 is configured to capture images of an item passing through any of the entrance openings as the item is being loaded into or is being removed from the corresponding storage compartment.

The computing device 120 controls the light source 112 (depicted schematically in FIGS. 2 and 3 as a plurality of lights, but can be similar to panel lighting in known refrigerators) during a session for optimized processing by computer vision models described below. The computing device 120 also controls configuration aspects of each camera in the plurality of cameras 110 including a frame rate and an exposure for optimized processing by the computer vision models.

With reference to FIGS. 1 and 2, the refrigerator 102 includes the trigger switch 104 mounted to the main body 140. The trigger switch 104 is operably connected with the computing device 120 and configured for detecting a position of the door 142 to indicate whether the door 142 is in the open position or the closed position. In this manner, the trigger switch 104 is configured to send a trigger signal to the computing device 120 based on whether the door 142 is in the open position or the closed position. More specifically, the trigger switch 104 is configured to send a start trigger signal to the computing device 120 when the door 142 moves from the closed position toward the open position, and the trigger switch 104 is configured to send a stop trigger signal to the computing device 120 when the door 142 moves from the open position to the closed position. The trigger switch 104 may include at least one of various types of position sensors such as mechanical switches, potentiometers, piezoelectric sensors, Hall effect sensors, and eddy-current sensors without departing from the scope of the present disclosure. Also, while the trigger switch 104 is shown disposed on the main body 140, the trigger switch 104 may additionally or alternatively be positioned on the door 142.

The door angle sensor 116 is configured to determine the angle of the door 142 with respect to the main body 140. The door angle sensor 116, for example, could include a rotary encoder having a shaft the rotates as the door 142 pivots with respect to the main body 140 to output and communicate with the computing device 120 to communicate the relative angular position of the door 142 with respect to the main body 140. The start trigger signal discussed above could also be generated by the door angle sensor 116 indicating that the door 142 has moved from the closed position toward the open position. Moreover, any of the plurality of cameras 110 may also be used to generate the start trigger signal when within a respective camera's field of view there is an indication that the door 142 has moved from the closed position toward the open position.

The ambient light sensor 118 can be mounted to the main body 140 (as shown in FIGS. 2 and 3), to the door 142 or elsewhere. The ambient light sensor 118 is configured to cooperate with the computing device 120 to determine an ambient light parameter outside of the main body 140 based on signals received from the ambient light sensor 118. The ambient light sensor 118 can include a phototransistor, a photodiode and photonic integrated circuits. The ambient light sensor 118 can further include both ambient light intensity (lux) sensing capability and color temperature or light correlated color temperature (CCT) sensing capability, which can be measured in Kelvin. The ambient light sensor 118 can further include both RGB (Red, Green, Blue) and XYZ light sensors for precise color measurement, determination, and discrimination. In addition, the ambient light sensor 118 can further include multi-spectral sensing capability, which includes an array of spectral sensing devices providing between a plurality, e.g., between 6 and 18, channels in the visible and near-infrared spectrum.

Referring back to FIG. 1, the computing device 120 includes a processor 464, a memory 470, a data store 472, and a communication interface 474, which are each operably connected for computer communication via the bus 124. The communication interface 474 provides software and hardware to facilitate data input and output between the components of the computing device 120 and other components, networks, and data sources, which will be described herein.

The computing device 120 is in operable connection with the plurality of cameras 110. The computing device 120 can also include a session controller module 480 that is configured to start a session and to instruct each camera in the plurality of cameras 110 to begin capturing images based on the start trigger signal received by the session controller module 480. The plurality of cameras 110 begin capturing images after the session controller module 480 receives the start trigger signal, and the plurality of cameras 110 cease capturing images after the session controller module 480 receives the stop trigger signal from the trigger switch 104. The plurality of cameras 110 can each be configured to compress captured images and to assign particular identification data to the captured images for later processing having to do with inventory tracking for the refrigerator 102.

The computing device 120 can also include an object identification module 490 that can be configured to determine whether each captured image contains an object, to define a bounding box around each object located in the respective captured image and to assign a class identification to the object. The object identification module 490 can include a computer vision model that outputs a bounding box around the object and the class identification for the object for each captured image. In an embodiment, the computer vision model is YOLOv5, however the object identification module 490 may include additional or alternative computer vision models for determining object presence and class identification in the refrigerator 102 without departing from the scope of the present disclosure. The computing device 120 can include further modules to track objects among the images taken from the plurality of cameras 110, to determine the direction in which the object is moving and to update the inventory of the refrigerator 102 that will not be described with particularity for the sake of brevity.

As can be appreciated, the better the images that can be captured by the plurality of cameras 110, the higher the confidence in classifying the object in the captured image. With that in mind, the computing device 120 can be in operable connection with the plurality of cameras 110, the ambient light sensor 118, and the light source 112, and the computing device 120 can be configured to determine an ambient light parameter outside of the main body 140 based on signals received from the ambient light sensor 118 and to control at least one of the light source 112 and the plurality of cameras 110 based on the ambient light parameter that has been determined.

For example, the computing device 120 can be configured to cooperate with the light source 112 to control a quantity or a quality of light generated by the light source 112 based on the ambient light parameter that has been determined. The aforementioned quantity of light generated by the light source 112 can be measured in candela, lumens or footcandles, for example. The computing device 120 can be configured to cooperate with the light source 112 to control the quantity of light generated by the light source 112 such that a relatively higher quantity of light is generated by the light source 112 for a first ambient light intensity as compared to for a second ambient light intensity that is greater than the first ambient light intensity. As a more specific example, if the ambient light intensity (lux) detected by the ambient light sensor 118 is relatively low, e.g., there are no lights on in the room with the refrigerator, then the computing device 120 can control the light source 112 to generate a relatively higher light output, e.g., candela, lumens or footcandles, as compared to a relatively lower light output when the light intensity detected by the ambient light sensor 118 is relatively higher, e.g., there are several lights on or generally more illumination in the room with the refrigerator 102.

As mentioned above, the computing device 120 can be configured to cooperate with the light source 112 to control a quantity or a quality of light generated by the light source 112 based on the ambient light parameter that has been determined. As it relates to the quality of light that is generated, the quality of light generated by the light source 112 can include a color temperature of the light that is generated, which can be measured in Kelvin. The quality of light generated by the light source 112 can also include the actual color of light that is generated, i.e., the wavelength of the light being generated. In these instances, the light source 112 can be made up of a plurality of LEDs that allow particular LEDs to be operated to provide a particular color temperature. The light source 112 can also include a plurality of LEDs that each illuminate to provide a particular color to allow the light source 112 to generate light of different colors based on signals received from the ambient light sensor 118 by the computing device 120.

As mentioned above, the ambient light sensor 118 can be configured to detect different colors of light received. For example, the ambient light sensor 118 can be configured to detect received light intensity for red, blue and green light respectively. In such an instance, the quality of light generated by the light source 112 can be based on the received light intensity for red, blue and green light respectively received by the ambient light sensor 118. The color temperature of the light that is generated, which can be measured in Kelvin, or the actual color of light that is generated by the light source 112 can be based on the received light intensity for red, blue and green light respectively received by the ambient light sensor 118.

The computing device 120 can be configured to cooperate with the plurality of cameras 110 to control aperture, shutter speed or gain for at least one camera among the plurality of cameras 110 based on the ambient light parameter that has been determined. Aperture refers to how much light enters the camera. Shutter Speed controls how long light enters the camera. Gain refers to an amplification of the electrical signal sent from the image sensor of the camera.

The computing device 120 can be configured to control at least one of the light source 112 and at least one camera among the plurality of cameras 110 based on the angle of the door 142 with respect to the main body 140. As mentioned above, the door angle sensor 116 is configured to determine an angle of the door 142 with respect to the main body 140 when the door 142 is in the open position. The angle of the door 142 with respect to the main body 140 can impact the intensity of light in front of the main body 140 leading to at least one storage compartment within a refrigerated enclosure. For example, if the ambient light sensor 118 is mounted to the top of the main body 140, as shown in FIGS. 1 and 2, the ambient light sensor 118 may detect more light intensity than the actual light intensity in front of the main body 140 leading to at least one storage compartment within a refrigerated enclosure when the door 142 is at an acute angle with respect to the main body 140. As such, this parameter may also be useful in controlling at least one of the light source 112 and at least one camera among the plurality of cameras 110.

Data gleaned from the signals received from the ambient light sensor 118, e.g., overall light intensity (lux), color temperature, correlated color temperature, light intensity for particular wavelengths (RGB), can be fed as input parameters into a machine learning model to control at least one of the light source 112 and at least one camera among the plurality of cameras 110 based on the ambient light parameter that has been determined. Through the use of the data gleaned from the signals received from the ambient light sensor 118 and the machine learning model, the intent is to optimize the images captured by the plurality of cameras 110 for later processing by the object identification module 490. In addition, data gleaned from the signals received from the door angle sensor 116 can be fed as input parameters into the machine learning model to control at least one of the light source 112 and at least one camera among the plurality of cameras 110 based on the door angle sensed by the door angle sensor 116.

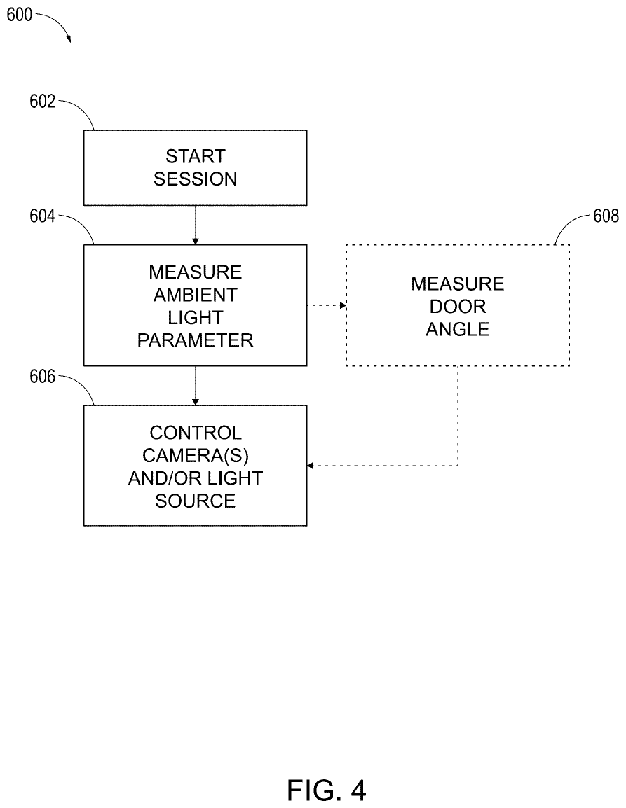

FIG. 4 is a flow diagram of a computer-implemented method 600 for controlling at least one of the light source 112 and at least one camera among the plurality of cameras 110. The computer-implemented method 600 may include starting a session 602, via the computing device 120, in response to a start trigger signal indicating the door 142 has moved from a closed position to an open position. The computer-implemented method 600 may further include measuring 604, via the ambient light sensor 118, an ambient light parameter at least in front of the door 142 of the refrigerator 102, and controlling 606, during the session, at least one of the light source 112 and a camera among the plurality of cameras 110, via the computing device 120, based on the ambient light parameter and the start trigger signal.

Measuring 604 the ambient light parameter may further include measuring light intensity for red, blue and green light respectively. Controlling 606 at least one of the light source 112 and a camera among the plurality of cameras 110 may further include controlling a quantity of light generated by the light source 112 such that a relatively higher quantity of light is generated by the light source 112 for a first ambient light intensity as compared to for a second ambient light intensity that is greater than the first ambient light intensity. In addition or alternatively, controlling 606 at least one of the light source 112 and a camera among the plurality of cameras 110 may further include controlling a color temperature or at least one color of the light generated by the light source 112 based on the ambient light parameter. Also, in addition or alternatively, controlling 606 at least one of the light source 112 and a camera among the plurality of cameras 110 may further include controlling aperture, shutter speed or gain for at least one camera among the plurality of cameras 110 based on the ambient light parameter.

If desired, the computer-implemented method 600 may include measuring 608, via the door angle sensor 116, an angle of the door 142 with respect to a main body 140 when the door is in an open position. In such an instance, controlling 606 at least one of the light source 112 and a camera among the plurality of cameras 110 may further include controlling at least one of the light source 112 and at least one camera among the plurality of cameras 110 based on the angle of the door 142 with respect to the main body 140.

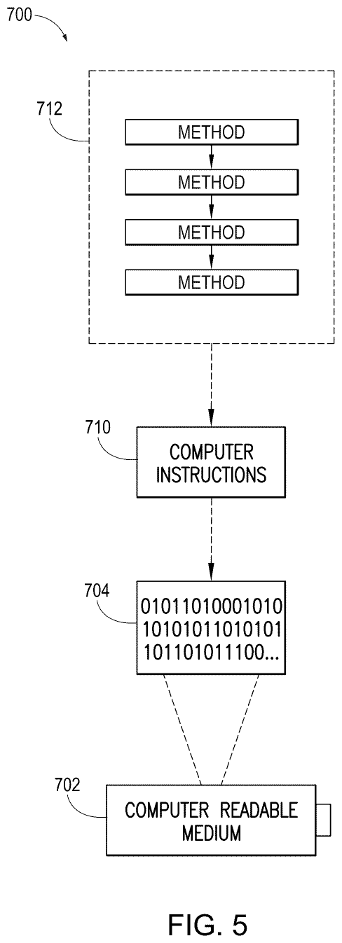

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 700 includes a computer-readable medium 702, such as a CD-R, DVD-R, flash drive, a platter of a hard disk drive, etc., on which is encoded computer-readable data 704. This encoded computer-readable data 704, such as binary data including a plurality of zero's and one's as shown in 704, in turn includes a set of processor-executable computer instructions 710 configured to operate according to one or more of the principles set forth herein. In this implementation 700, the processor-executable computer instructions 710 may be configured to perform a method 712, such as the computer-implemented method 600 of FIG. 4. In another aspect, the processor-executable computer instructions 710 may be configured to implement a system, such as the operating environment 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A refrigerator system comprising:
a main body and a door mounted to and movable with respect to the main body between an open position and a closed position, the main body defining at least one storage compartment within a refrigerated enclosure when the door is in the closed position;
an ambient light sensor mounted to the main body or to the door;
a light source mounted to the main body or to the door, the light source being configured to illuminate the refrigerated enclosure when the door is in the open position;
at least one camera positioned to have a field of view that includes an entrance opening leading to the at least one storage compartment, the at least one camera being configured to capture images of an item being loaded into or being removed from the at least one storage compartment; and
at least one computing device in operable connection with the at least one camera, the ambient light sensor, and the light source, the at least one computing device configured to:
determine an ambient light parameter outside of the main body based on signals received from the ambient light sensor; and
control at least one of the light source and the at least one camera based on the ambient light parameter that has been determined.

2. The refrigerator system of claim 1, wherein the at least one computing device is configured to cooperate with the light source to control a quantity or a quality of light generated by the light source based on the ambient light parameter that has been determined.

3. The refrigerator system of claim 2, wherein the quantity of light generated by the light source is measured in candela, lumens or footcandles.

4. The refrigerator system of claim 2, wherein the at least one computing device is configured to cooperate with the light source to control the quantity of light generated by the light source such that a relatively higher quantity of light is generated by the light source for a first ambient light intensity as compared to for a second ambient light intensity that is greater than the first ambient light intensity.

5. The refrigerator system of claim 2, wherein the quality of light generated by the light source includes a color temperature of the light that is generated.

6. The refrigerator system of claim 2, wherein the quality of light generated by the light source includes at least one color of the light that is generated.

7. The refrigerator system of claim 2, wherein the at least one computing device is configured to cooperate with the at least one camera to control aperture, shutter speed or gain for the at least one camera based on the ambient light parameter that has been determined.

8. The refrigerator system of claim 1, wherein the at least one computing device is configured to cooperate with the at least one camera to control aperture, shutter speed or gain for the at least one camera based on the ambient light parameter that has been determined.

9. The refrigerator system of claim 1, wherein the ambient light sensor is further configured to detect different colors of light received.

10. The refrigerator system of claim 9, wherein the ambient light sensor is configured to detect received light intensity for red, blue and green light respectively.

11. The refrigerator system of claim 10, wherein the at least one computing device is configured to cooperate with the at least one camera to control aperture, shutter speed or gain for the at least one camera based on the received light intensity for red, blue or green respectively.

12. The refrigerator system of claim 10, wherein the at least one computing device is configured to cooperate with the light source to control a quality of light generated by the light source based on the received light intensity for red, blue or green respectively.

13. The refrigerator system of claim 12, wherein the quality of light generated by the light source includes at least one color of the light that is generated.

14. The refrigerator system of claim 1, further comprising a door angle sensor configured to determine an angle of the door with respect to the main body when the door is in the open position, and the at least one computing device further configured to:
control at least one of the light source and the at least one camera based on the angle of the door with respect to the main body.

15. A computer-implemented method for operating a refrigerator comprising:
starting a session, via at least one computing device, in response to a start trigger signal received by the at least one computing device indicating a door to the refrigerator has moved from a closed position to an open position;
measuring, via an ambient light sensor, an ambient light parameter at least in front of the door of a refrigerator; and
controlling, during the session, at least one of a light source and a camera, via the at least one computing device in communication with the light source and the camera, based on the ambient light parameter and the start trigger signal.

16. The computer-implemented method of claim 15, wherein measuring, via the ambient light sensor, the ambient light parameter at least in front of the door of the refrigerator further includes:
measuring light intensity for red, blue and green light respectively.

17. The computer-implemented method of claim 15, wherein controlling at least one of the light source and the camera, via the at least one computing device in communication with the light source and the camera, based on the ambient light parameter and the start trigger signal further includes:
controlling a quantity of light generated by the light source such that a relatively higher quantity of light is generated by the light source for a first ambient light intensity as compared to for a second ambient light intensity that is greater than the first ambient light intensity.

18. The computer-implemented method of claim 15, wherein controlling at least one of the light source and the camera, via the at least one computing device in communication with the light source and the camera, based on the ambient light parameter and the start trigger signal further includes:
controlling a color temperature or at least one color of the light generated by the light source based on the ambient light parameter.

19. The computer-implemented method of claim 15, wherein controlling at least one of the light source and the camera, via the at least one computing device in communication with the light source and the camera, based on the ambient light parameter and the start trigger signal further includes:
controlling aperture, shutter speed or gain for the camera based on the ambient light parameter.

20. The computer-implemented method of claim 15, further comprising:
measuring, via a door angle sensor, an angle of the door with respect to a main body when the door is in an open position,
wherein controlling at least one of the light source and the camera, via the at least one computing device in communication with the light source and the camera, based on the ambient light parameter and the start trigger signal further includes:
controlling at least one of the light source and the camera based on the angle of the door with respect to the main body.
